(19) United States
(12) Patent Application Publication
(10) Pub. No.: US 2003/0165259 A1
(43) Pub. Date: Sep. 4, 2003

(54) Signal analysis using image processing techniques

(76) Inventors: James S. Balent, Cedar Park, TX (US); Morten O. J. Jensen, Austin, TX (US)

Correspondence Address: Jeffrey C. Hood, Meyertons, Hood, Kivlin, Kowert & Goetzel, P.O. Box 398, Austin, TX, 78767, US

(21) Appl. No.: 10/365,568

(22) Filed: Feb. 12, 2003

Related U.S. Application Data
(60) Provisional application No. 60/357,691, filed on Feb. 15, 2002.

(51) Int. Cl. G06K 9/00; G06K 9/46

(52) U.S. Cl. 382/113; 382/190

(57) ABSTRACT

System and method for analyzing communication signals using image processing techniques. A computer includes image acquisition (IMAQ) hardware and one or more image processing/analysis programs. The computer is coupled to an instrument which receives and/or generates signals, and produces signal image data, e.g., VGA data, which is transmitted to the computer's memory through the IMAQ hardware. The image processing programs process the signal image data to detect image features. An analysis program analyzes the detected features to generate signal analysis results characterizing the signal, which are output. The signal image data may include eye diagrams for high-speed digital communication signal analysis. The signal analysis results may include rise time, fall time, jitter RMS (root mean square), jitter p-p, period, frequency, positive/negative pulse width, duty cycle, duty cycle distortion, delta time, extinction ratio, average power, crossing percentage, one/zero levels, eye height, width, and amplitude, Q-factor, bit rate, opening factor, and contrast ratio.

### PRIORITY CLAIM

This application claims benefit of priority of U.S. provisional application Serial No. 60/357,691 titled “Signal Analysis Using Image Processing Techniques” filed Feb. 15, 2002, whose inventor is James S. Balent.

### FIELD OF THE INVENTION

The present invention relates to a system and method for performing signal analysis using image processing and analysis techniques. More particularly, the invention uses image processing techniques to analyze image data associated with data and communication signals.

### DESCRIPTION OF THE RELATED ART

Signal communications have become central to many aspects of the modem world. In fact, virtually all modem business, manufacturing, engineering, and scientific enterprises rely substantially on signal communications to perform their activities. To support this ubiquitous phenomenon, a vast and varied technological infrastructure has been, and continues to be, developed, including wireless and wired telecommunications media, fiber-optic components, routers, transmitters, analog and digital signal processing chips, and myriad software programs for managing, processing, analyzing, and transmitting these signals, among others. These communications related components generally require testing and diagnostic analysis to ensure proper behavior and/or design, as well as calibration and tuning for particular applications.

The ever-increasing speeds of data and communication signals result in new or changing design and test challenges—including the increased likelihood of pattern-dependent failures. As bit rates increase to 10 Gb/s and beyond, pattern-dependent failures become much more common in the generation, transmission, and reception of signals in various data and communication products and systems. Unfortunately with traditional test technologies, it is often difficult and time-consuming to reliably identify and observe these failures. Bit error rate testers can be used to determine the total number of bit failures in the generated bit stream, but may not identify the specific patterns that caused the failures.

In the field of high-speed communications, where signal frequencies may reach into the multi-gigahertz range, analysis of chips and/or other hardware components is generally performed by high-performance digital sampling instruments, such as the 86100B Infiniium DCA Wide-Bandwidth Oscilloscope, made by Agilent Technologies, or the CSA 8000 digital sampling oscilloscope, made by Tektronix. These devices may be capable of numerically processing tens of thousands of bits to analyze signals characterizing the behavior of communication components, for example, high-speed optical transmitters operating in the 100 Mb/s-40 Gb/s range.

Eye diagrams are a common way to analyze the performance of high-speed communication systems and are the primary tool for most digital communication analysis. Eye diagrams are generated by transmitting random digital communication signals into a communication medium (optical fiber, co-axial cable, air/wireless, etc.) and sampling the output on a high-speed sampling oscilloscope. The oscilloscope is typically triggered externally from a reference clock signal from the transmitter (via a phased locked loop). The resulting pattern on the oscilloscope is the jittered digital pattern signals superimposed on each other. Over successive sweeps, the random bit patterns build up a composite picture of all the possible pattern sequences and transitions (low to low, high to high, high to low, and low to high). An example of an eye diagram is described below with reference to FIG. 3.

Through analysis of an eye diagram image one may determine network and communication variables such as jitter, noise, pulse degradation, and intersymbol interference, among others. Eye diagram analysis may also facilitate mask testing. Specific parameters that can be determined from the eye diagram include, but are not limited to, extinction ratio, eye height, eye width, signal to noise ratios and Q-factors, duty cycle, bit rate, rise times, fall times, and eye amplitude. These parameters are typically calculated using values like the eye diagram “eye opening” which is the large open area at the center of the pulse, the “eye height” which is the distance between the top and bottom of the pulse, “eye width” which is the distance between the transitions, and crossing points and slopes which are where the pulses meet on each side.

Traditional eye diagrams are created with high-speed digital sampling scopes like the Agilent 86100A wide-bandwidth oscilloscope and the Tektronics CSA8000 communications analyzer. These stand-alone instruments have built in functionality to numerically determine communication performance parameters like extinction ratio, eye height, eye width, signal to noise ratios, etc., mentioned earlier. Additionally, various software products are available for digital communication analysis and have special math functions to analyze eye diagram data. For example, SyntheSys Research, Inc. provides digital communication analysis software to Agilent for use in its high-speed oscilloscope.

However, problems or issues related to the use of stand-alone instrumentation such as the Agilent Technologies or Tektronics communication oscilloscopes for doing eye diagram analysis include speed of data analysis, and transmission times for sending the data to a computer. For example, enough signal sweeps must be acquired by the oscilloscope to generate enough data to make accurate eye diagram measurements. Often, this can take hundreds to thousands of milliseconds to generate acceptable eye diagrams. Then, the actual processing of the data must occur. Currently, some digital communication analyses can take several seconds to perform the necessary calculations. Finally, a certain amount of time is needed to send the information from the oscilloscope to a controlling computer through a standard communication bus (e.g. Ethernet, IEEE 488, or serial). Furthermore, some sampling oscilloscopes have to record the collected and analyzed data to an internal hard-drive before sending the data over the communication bus to the computer, which can take tens of seconds to complete. Thus, total times for signal analysis (including transmission times) may easily approach tens of seconds per analysis.

As oscilloscope technology evolves and oscilloscopes use faster internal processors, the analysis time should decrease. Unfortunately, faster processors in the oscilloscopes and higher-speed communication interfaces may not meet the time constraints of large-scale production test environments or manufacturing systems. In these applications, a central computer needs to communicate to many different instrumentation and control electronics very quickly—e.g. pattern generators, voltmeters, and digital sampling scopes. Based on the information from these instrumentation and control modules, certain actions must be taken quickly, e.g., at rates of tens of times per second or more.

For example, when building transceivers for optical networks, it is necessary to test the transceiver module via an eye diagram to determine if it is performing to specification. If the eye diagram is not acceptable then the transceiver is not operating properly and must be “tuned”, or programmed, with new operating parameters. After the transceiver module is programmed with the new operating parameters, eye diagram measurements are made again and performance is analyzed. This eye diagram analysis and transceiver tuning is repeated until an acceptable eye diagram test is passed. For high-speed production test environments, this tuning process (with eye diagram test) must occur as fast as possible. However, using standard oscilloscopes like the Agilent 86100A may take tens of seconds to acquire, analyze, and present eye diagram information via a communications bus such as IEEE-488 or Ethernet to the central computer. In other words, for many applications the eye diagram analysis requires too much time.

The analysis of communication signals via eye diagrams is but one example of numerical processing of signal data. Other applications, such as waveform analysis and signal characterization, may involve similar problems with regard to data loads and transmission times, especially when real time performance is required.

Thus, improved systems and methods for performing signal analysis are desired.

### SUMMARY OF THE INVENTION

A system and method are presented for analyzing signals using image processing techniques. A computer system may be coupled to an instrument, e.g., an oscilloscope, via a bus, or over a network, such as the Internet. The instrument, e.g., the oscilloscope, may be operable to generate signals or receive signals from a signal source, and generate signal image data from the signals. The signal image data may comprise VGA image data, although other image data protocols are also contemplated.

The computer system includes image acquisition (IMAQ) and/or analysis hardware, such as an IMAQ card (e.g., from National Instruments Corporation) installed in the computer system, or an external image acquisition device coupled to the computer system. The IMAQ hardware may be operable to receive image data from the instrument, e.g., in the form of VGA data, and to send the image data to a memory medium of the computer system. The computer system also includes one or more software programs executable to perform image processing and/or analysis on the received image data, thereby producing signal analysis results characterizing one or more aspects of the signal. The software programs may be stored in the memory medium of the computer system.

In one embodiment, signal image data may be received and stored on the computer system. For example, in one embodiment, IMAQ hardware comprised in or coupled to the computer system may receive the signal image data from the instrument, e.g., the oscilloscope, where the signal image data corresponds to data or communications signals generated by the instrument, or signals received by the instrument from an external signal source. In one embodiment, the signals corresponding to the signal image data may be optical communication signals. For example, the signals may be digital communication signals, e.g., “square waves”, in the 100 Mb/s to 40 Gb/s range. In various other embodiments, the signals may comprise digital and/or analog signals of various frequencies and waveforms. In an exemplary embodiment, the signal image data may comprise an eye diagram, as is well known in the art. In one embodiment, the signal image data may be in the form of VGA data, although any other image signal protocol may also be used as desired.

Image processing may be performed on the received signal image data, e.g., by one or more IMAQ programs executed by the computer system, using image processing techniques on the image data to detect image features such as edges, boundaries, regions, and/or curves characterizing the image data. Note that, as used herein, the term “IMAQ program” refers to both image acquisition software, and image processing software. Then, the detected image features may be analyzed to determine various metrics and/or relationships among the detected features which characterize the signal, thereby producing signal analysis results. The signal analysis results may include, but are not limited to, one or more of rise time, fall time, jitter RMS (root mean square), jitter p-p, period, frequency, positive pulse width, negative pulse width, duty cycle, delta time. In an embodiment where the signal image data comprises an eye diagram for high-speed digital communication analysis, the signal analysis results may include, but are not limited to, one or more of extinction ratio, jitter RMS, jitter p-p, average power, crossing percentage, rise time, fall time, one level, zero level, eye height, eye width, signal to noise (Q-factor), duty cycle distortion, bit rate, eye amplitude, opening factor, and contrast ratio, as are well known in the art. Mask tests may also be performed based on the signal image data.

Finally, the signal analysis results may be output, e.g., to a display, a log, a memory location, and/or to an external system, such as a device or other external computer coupled to the computer system.

Thus, in various embodiments, the system and method operates to analyze signals using image processing techniques. Such analysis may be applicable in a variety of fields, including hardware testing and diagnostics, manufacturing, monitoring, quality control, and telecommunications, among others.

### BRIEF DESCRIPTION OF THE DRAWINGS

A better understanding of the present invention can be obtained when the following detailed description of the preferred embodiment is considered in conjunction with the following drawings, in which:

FIG. 1 illustrates a signal analysis system, according to one embodiment of the invention;

FIG. 2 flowcharts one embodiment of a method for performing signal analysis using image processing techniques;

FIG. 3 illustrates an eye diagram for analyzing highspeed digital communication signals, according to one embodiment; and

FIG. 4 illustrates various geometrical features of an eye diagram, according to one embodiment.

While the invention is susceptible to various modifications and alternative forms specific embodiments are shown by way of example in the drawings and are herein described in detail. It should be understood, however, that drawings and detailed description thereto are not intended to limit the invention to the particular form disclosed. But on the contrary the invention is to cover all modifications, equivalents and alternatives falling within the spirit and scope of the present invention as defined by the appended claims.

### DETAILED DESCRIPTION OF THE EMBODIMENTS

### Incorporation by Reference

The following publications are hereby incorporated by reference in their entirety as though fully and completely set forth herein:

The Agilent 86100B Wide-Bandwidth Oscilloscope Technical Specifications, ©2000, 2001 Agilent Technologies, Printed in USA Dec. 21, 2001, 5988-5311EN;

The Tektronix CSA8000B Communications System Analyzer Technical Specifications, 85W-13499-4p1, 02/2000, Jan. 28, 2002; and

The National Instruments IMAQ™ IMAQ Vision Concepts Manual.

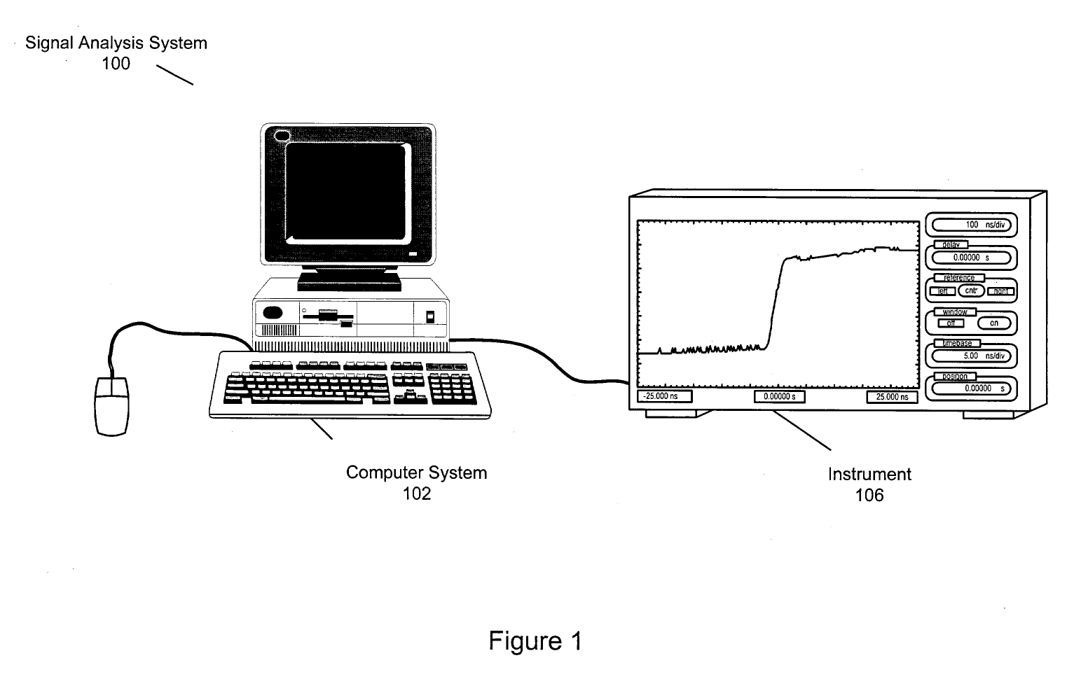

FIG. 1—Signal Analysis System

FIG. 1 illustrates a signal analysis system 100 which may be operable to perform signal analysis, according to one embodiment of the present invention. As FIG. 1 illustrates, the signal analysis system 100 may include a computer system 102 coupled to an instrument 106, e.g., an oscilloscope, via a bus, or over a network, such as the Internet. The computer system 102 may comprise one or more processors, a memory medium, display, an input device or mechanism, such as a keyboard or mouse, and any other components necessary for a computer system.

The instrument 106, e.g., the oscilloscope, may be operable to receive signals from a signal source, and generate signal image data from the signals. Alternatively, the instrument 106 may generate the signals internally and produce signal image data corresponding to the generated signals. In one embodiment, the signal image data may comprise VGA image data, although other image data protocols are also contemplated for use by various embodiments of the invention.

The computer system 102 may include image acquisition (IMAQ) and/or analysis hardware, such as an IMAQ card (e.g., from National Instruments Corporation) installed in the computer system 102, or an external image acquisition device coupled to the computer system 102. The IMAQ hardware may be operable to receive image data from the instrument 106, e.g., in the form of VGA data, and send the image data to the memory medium of the computer system 102. The computer system 102 preferably includes one or more software programs executable to perform image processing and/or analysis on the received image data, thereby producing signal analysis results characterizing one or more aspects of the signal. The software programs may be stored in the memory medium of the computer system 102

The term “memory medium” is intended to include various types of memory, including an installation medium, e.g., a CD-ROM, or floppy disks 104, a computer system memory such as DRAM, SRAM, EDO RAM, Rambus RAM, etc., or a non-volatile memory such as a magnetic medium, e.g., a hard drive, or optical storage. The memory medium may comprise other types of memory as well, or combinations thereof. In addition, the memory medium may be located in a first computer in which the programs are executed, or may be located in a second different computer which connects to the first computer over a network. In the latter instance, the second computer may provide the program instructions to the first computer for execution. Also, the computer system 102 may take various forms, including a personal computer system, mainframe computer system, workstation, network appliance, Internet appliance, personal digital assistant (PDA), television system or other device. In general, the term “computer system” can be broadly defined to encompass any device having a processor which executes instructions from a memory medium.

The software program(s) may be implemented in any of various ways, including procedure-based techniques, component-based techniques, graphical programming techniques, and/or object-oriented techniques, among others. For example, the software program may be implemented using ActiveX controls, C++ objects, Java Beans, Microsoft Foundation Classes (MFC), or other technologies or methodologies, as desired. A CPU, such as the host CPU, executing code and data from the memory medium comprises a means for performing signal analysis according to the methods described below.

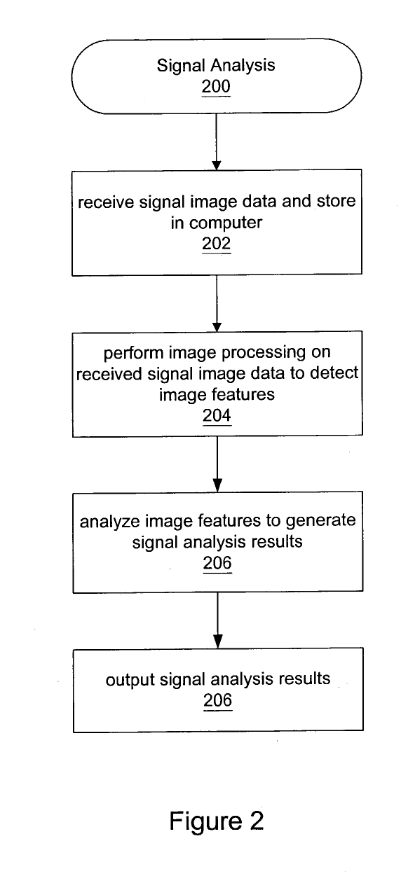

FIG. 2—Method for Performing Signal Analysis Using Image Processing Techniques

FIG. 2 is a flowchart diagram illustrating one embodiment of a method for performing signal analysis using image processing and analysis techniques.

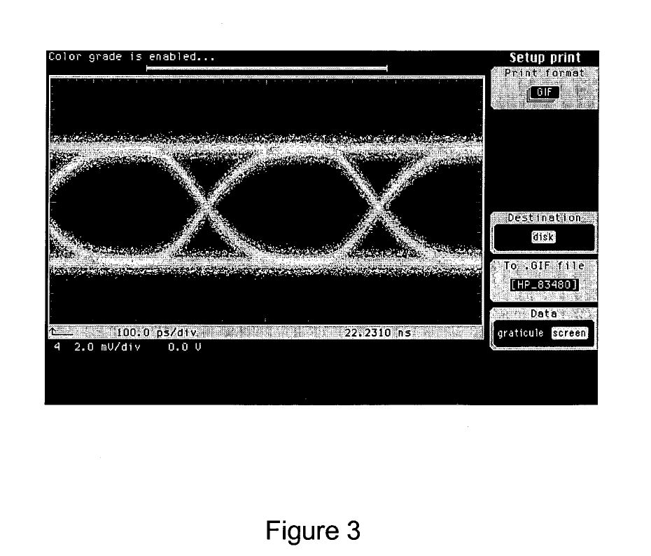

As FIG. 2 shows, in 202, signal image data may be received and stored on the computer system 102. For example, in one embodiment, IMAQ hardware comprised in or coupled to the computer system 102 may receive the signal image data from an instrument 106, such as an oscilloscope. The signal image data may correspond to data or communications signals generated by the instrument 106, or data or communications signals received by the instrument from an external signal source. In one embodiment, the signals corresponding to the signal image data may be optical communication signals. For example, the signals may be digital communication signals, e.g., “square waves”, in the 100 Mb/s to 40 Gb/s range. In various other embodiments, the signals may comprise digital and/or analog signals of various frequencies and waveforms. In an exemplary embodiment, the signal image data may comprise an eye diagram, as described below with reference to FIG. 3.

State-of-the-art stand-alone instrumentation with fast enough sample rates to generate eye diagrams are generally built with computer technology, and as a result generally have VGA video outputs. Thus, as mentioned above, in one embodiment, the signal image data may be in the form of VGA data, although any other image signal protocol may also be used as desired.

In 204, image processing may be performed on the received signal image data. In other words, one or more IMAQ programs may execute to analyze the signal image data. As noted above, the term “IMAQ program” refers to both image acquisition software and image processing software. The IMAQ programs may use image processing techniques on the image data to detect image features such as edges, boundaries, regions, and/or curves characterizing the signal image data.

Then, in 206, the detected image features may be analyzed to determine various metrics and/or relationships among the detected features which characterize the signal, thereby producing signal analysis results. In one embodiment, the signal analysis results may include, but are not limited to, one or more of rise time, fall time, jitter RMS (root mean square), jitter p-p, period, frequency, positive pulse width, negative pulse width, duty cycle, delta time. In an embodiment where the signal image data comprises an eye diagram for high-speed digital communication analysis, the signal analysis results may include, but are not limited to, one or more of extinction ratio, jitter RMS, jitter p-p, average power, crossing percentage, rise time, fall time, one level, zero level, eye height, eye width, signal to noise (Q-factor), duty cycle distortion, bit rate, eye amplitude, opening factor, and contrast ratio, as are well known in the art. As mentioned above, in one embodiment, mask tests may also be performed based on the signal image data.

Finally, in 208, the signal analysis results may be output. For example, the signal analysis results may be output to a display, a log, a memory location, or to an external system, such as a device or other external computer coupled to the computer system 102.

Thus, connecting the VGA output to an image capture card inside the computer 102 and using vision processing tools, i.e., IMAQ programs, may allow the user interface screen data, i.e., the displayed image, of the stand-alone sampling instrument (e.g., oscilloscope) to be transferred into the computer memory. The computer 102 may then optionally display the user interface, i.e. the image of the eye diagram, and use the image processing tools to perform eye diagram analysis and/or other digital communication analyses using visual or image processing methods. In other words, the use of image processing software technology may provide a very fast method for extracting eye diagram measurements and storing the results in a computer 102. This is a different approach from other eye diagram analysis methods that look at numeric values of the eye diagrams (for example, arrays of numbers) and analyze the data mathematically or numerically.

Thus, in contrast to prior art signal analysis based on numerical methods, various embodiments of the system and method described herein may utilize image processing techniques to rapidly and efficiently extract various metrics from image data derived from the signal. It is estimated that in some embodiments, high-speed digital communication signal analyses which may take on the order of tens of seconds to perform using numerical techniques (with commensurate data processing loads and transmission times) may be performed in less than a second, e.g., 0.1 second, using image processing techniques, thereby allowing many such analysis tasks to be performed in real time, e.g, 10/s. For example, in manufacturing and testing applications, an improvement in testing and diagnostic times of one or two orders of magnitude may dramatically streamline overall production, with resultant improved economies of time and scale.

As mentioned above, one benefit which may be provided by using vision or image processing for digital communication analysis is that faster analysis of the data (image processing versus mathematical or numerical) is possible. Additionally, the fact that video signals (i.e., image data) are transmitted instead of signal data results in faster throughput of data from the instrument 106 (e.g., oscilloscope) to a computer 102. Furthermore, the use of image processing techniques to analyze and characterize the signal may mean that less data must be collected by the instrument 106 (e.g., oscilloscope). For example, a lower number of signal sweeps may be required to make a measurement. The fact that less data needs to be collected may result in a shorter total analysis time.

Thus, various embodiments of the present invention may use image processing techniques to perform signal analysis, e.g., analog and/or digital data and/or communication signal analysis. In one embodiment, National Instruments IMAQ Vision processing software and IMAQ Vision hardware may be used to collect front panel eye diagram information from high-speed digital sampling oscilloscopes. After the eye diagrams have been collected into a computer, IMAQ Vision image processing software may then be used to perform various eye diagram measurements to determine communication operation and/or behavior. Thus, eye diagram measurements may be made visually or through image processing techniques, rather than mathematically or numerically.

FIG. 3—Example Eye diagram

FIG. 3 illustrates an exemplary eye diagram suitable for analyzing digital communication signals, according to one embodiment. As FIG. 3 shows, the eye diagram typically comprises a large number of overlaid signal traces or samples, such as may be produced by a digital sampling oscilloscope. In the field of digital communications the eye diagram is used to visualize how the waveforms used to send multiple bits of data can potentially lead to errors in the interpretation of those bits, referred to as intersymbol interference (ISI). In general, the eye diagram is an intuitive measure of ISI.

The eye diagram is a geometrical representation of characteristic responses to a series of substantially square-wave signals or pulses. Typically, the pulses are so fast that the sampling oscilloscope is only able to capture a relatively small number of samples for a given pulse, thus, a particular signal trace may only present a fraction of the pulse, such as a sample point (or a few sample points) from the rising portion of the pulse, while subsequent traces may present samples from other portions of other pulses. Over time, a great number of these traces or samples may illustrate all of the various transition forms of the pulses, i.e., rise times, fall times, low (0) and high (1) levels, etc. Typically, an eye diagram includes thousands, and possibly tens of thousands, of sample points. The sheer volume of data typically required to generate an eye diagram for numerical analysis may present a number of constraints on the speed with which signal analysis may be performed.

As mentioned above, a number of signal characteristics may be determined from the eye diagram, including rise time, fall time, jitter RMS (root mean square), jitter p-p, period, frequency, positive pulse width, negative pulse width, duty cycle, delta time, average power, crossing percentage, one level, zero level, eye height, eye width, signal to noise (Q-factor), duty cycle distortion, bit rate, eye amplitude, opening factor, and contrast ratio, as are well known in the art. These metrics or measurements may be used to design, test, diagnose, and/or calibrate data or communication devices and media, as is well known by those skilled in the art.

As described above, the fact that the salient metrics characterizing the signal are reflected in visible geometric attributes of the visual display, i.e., the eye diagram, means that the eye diagram (in the form of image data) may be analyzed geometrically or visually, i.e., using image processing techniques, in contrast to the resource and time intensive numerical techniques used in the prior art. It should be noted that although the systems and methods of the present invention have been described primarily as applied to analysis of digital communication eye diagrams, various other embodiments of the invention are contemplated for use in the analysis of any other type of signal which may be represented by image data. In other words, various embodiments of the invention may be used to augment or replace numerical analysis techniques in the analysis of any signals, including analog and digital data and/or communications signals.

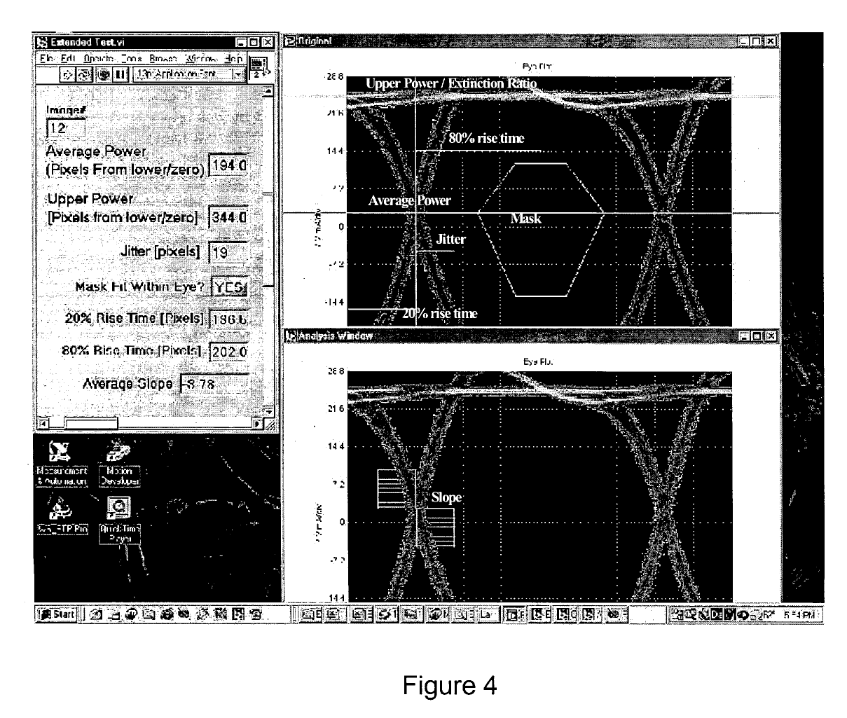

FIG. 4—Geometrical Features of Eye diagram

FIG. 4 illustrates various geometric features of an exemplary eye diagram, according to one embodiment. It is noted that the geometric features (and corresponding signal parameters) indicated in FIG. 4 are exemplary only, and are not intended to limit the features or parameters to any particular set.

In the embodiment shown in FIG. 4, the features or distances are calculated in pixel values and converted to appropriate units (time, power, etc.). It should be noted that many of the geometric features of the diagram, e.g., crossing points, distances, slopes, levels, etc., may be determined or calculated in more than one way. For example, the centers of the two crossing points may be determined by pattern matching (e.g., by pixel-based correlation), or by using edge-detection and other vision algorithms, among others. In further embodiments, color information from the VGA output of the oscilloscope may be used in performing the calculation, e.g., where color represents data point density. Once the crossing points are determined, subsequent features may be calculated using that information, such as, for example, average power, as described below.

As FIG. 4 shows, in one embodiment, the average power of the signal may be calculated by determining the average height, e.g., the average Y-value, where Y is the vertical axis) of the center crossing points (e.g., as indicated by the horizontal line running through both crossing points), and estimated upper and lower bounds of the eye diagram, i.e., the top and bottom of the eye. As also indicated in FIG. 4, the upper bound of the eye diagram represents an upper power of the signal, and may be estimated by determining the average height of the top of the eye diagram, illustrated in FIG. 4 as the upper horizontal line labeled “Upper Power/Extinction Ratio”. As is well known in the art, the average power and the upper power are typically determined relative to the lower bound of the eye diagram (not visible FIG. 4, but visible in FIG. 3), where the lower bound represents a lower power of the signal. In an ideal case, the lower bound has a value of zero, although typical real-world values are non-zero. The positions or values of the average, upper, and lower powers, referred to as power measurement lines, are preferably determined by various IMAQ vision analysis methods, such as edge-detection and pattern matching, among others.

Another geometric feature illustrated in FIG. 4 is 20% rise time, which may be determined by locating a point in the diagram at which a transition from 0 to 1 (i.e., bottom to top) has completed 20% (of the total transition), represented by a horizontal line labeled “20% Rise Time”. The actual time value may then be determined or calculated relative to the beginning of the rise. 80% rise time, represented in FIG. 4 by a horizontal line labeled “80% Rise Time”, may be calculated in a similar manner as the 20% rise time. In a preferred embodiment, edge detections may be used to determine or define the center of the eye diagram lines (i.e., the accumulated or collective traces), where the above measurements are made using the determined centers. If desired, 20% and 80% fall times may also be calculated to more completely characterize the signal quality (not shown in this figure.).

Another attribute that may be determined from the eye diagram is jitter, which refers to deviations from ideal timing of an event, as is well known in the art. The jitter may calculated at various points of the 0-1 and 1-0 crossing lines (only one is represented in FIG. 4). In the example shown, the jitter is represented by a horizontal line labeled “Jitter”, and indicates thickness of the eye diagram lines (collective traces). It should be noted that the trace thickness is preferably computed orthogonally to the measured trace. As noted above with respect to the 20% and 80% rise time calculations, the jitter is preferably calculated using edge detection algorithms.

Other useful geometric features that may be determined from the eye diagram via image processing are slopes of various lines or collective traces of the eye diagram. In the embodiment shown (bottom window of FIG. 4), slope is calculated using the center of the crossing line (which may be determined by a vision pattern matching algorithm), i.e., the crossing point. Four quadrants, defined by horizontal and vertical lines through the crossing point, partition the crossing or intersection into four lines (collective traces), and the slope of each line calculated, e.g., using a ‘best straight line’ vision or image processing algorithm.

As mentioned above, masks are often used in the analysis of eye diagrams. In one embodiment, a standard mask may be selected or determined, depending on the particular mask test desired, and used to further characterize the eye diagram. In FIG. 4, the mask is represented by a polygon in the center of the upper image labeled “Mask”. The determined mask may be programmatically placed in the eye diagram based on the determined geometric features described above, i.e., based on various “landmarks” of the eye diagram, such as average, upper, and lower powers, divergence of the (crossing) rising and falling lines, etc., and the mask geometry, depending on the particular standard mask used. Image processing, e.g., edge detection, may then be used to determine if there are any intersections between the mask edges (the sides of the polygon) and the eye diagram lines or collective traces. If there are intersections, then the mask test fails.

Other approaches to performing masks tests are also contemplated. For example, in another embodiment, a mask test may be performed on the eye diagram using binary morphology BLOB (Binary Large OBject) analysis, as is known in the art. Note that binary morphology BLOB analysis typically operates on a binary image, as opposed to a color or grayscale image. Thus, in an embodiment where the eye diagram is a color or grayscale image, a binary image may be generated internally by applying a threshold algorithm to the color or grayscale image, and then BLOB analysis performed on the resulting binary image to determine if the mask fits within the eye diagram.

Thus, various embodiments of the above described systems and methods utilize vision or image processing based techniques to analyze signal image data for characterization of signals. The techniques described herein are particularly suitable for analysis of eye diagrams related to high-speed digital communications, although any other type of signal or data may also be analyzed, as well.

Various embodiments further include receiving or storing instructions and/or data implemented in accordance with the foregoing description upon a carrier medium. Suitable carrier media include a memory medium as described above, as well as signals such as electrical, electromagnetic, or digital signals, conveyed via a communication medium such as networks and/or a wireless link.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A method for analyzing signals, the method comprising:
receiving signal image data corresponding to a signal;
performing image processing on the received signal image data;
generating signal analysis results based on said image processing; and
outputting the signal analysis results.

2. The method of claim 1, wherein said receiving signal image data corresponding to a signal comprises:
receiving signal image data from an instrument.

3. The method of claim 1, wherein said receiving signal image data corresponding to a signal comprises:
receiving VGA (Video Graphics Array) signal image data from the instrument via a VGA video output.

4. The method of claim 2, wherein said instrument comprises an oscilloscope.

5. The method of claim 2, wherein said signal image data correspond to signals generated by the instrument.

6. The method of claim 2, wherein said signal image data correspond to signals received by the instrument from an external signal source.

7. The method of claim 1, wherein said signal image data correspond to communications signals.

8. The method of claim 1, wherein said signal image data correspond to optical communication signals.

9. The method of claim 8, wherein said optical communication signals comprise digital communication signals in a range of approximately 100 Mb/s to approximately 40 Gb/s.

10. The method of claim 1, wherein said signal image data correspond to digital and/or analog signals.

11. The method of claim 1, wherein said performing image processing on the received signal image data comprises applying image processing techniques on the image data to detect image features characterizing the signal image data.

12. The method of claim 11, wherein said image features comprise one or more of: edges, boundaries, regions, and curves.

13. The method of claim 11, wherein said generating signal analysis results based on said image processing comprises:
analyzing the detected image features to generate one or more metrics characterizing the signal.

14. The method of claim 13, wherein said one or more metrics characterizing the signal comprises one or more of: rise time, fall time, jitter RMS (root mean square), jitter p-p, period, frequency, positive pulse width, negative pulse width, duty cycle, and delta tine.

15. The method of claim 1,
wherein the signal image data comprises an eye diagram;
wherein said performing image processing on the received signal image data comprises determining one or more features based on geometric properties of the eye diagram; and
wherein said generating signal analysis results based on said image processing comprises determining one or more attributes of the signal based on said one or more features.

16. The method of claim 15, wherein said features comprise one or more of: edges, boundaries, regions, and curves.

17. The method of claim 15, wherein said generating signal analysis results based on said image processing comprises:
analyzing the detected image features to generate one or more metrics characterizing the signal.

18. The method of claim 17, wherein said one or more metrics characterizing the signal comprises one or more of: extinction ratio, jitter RMS, jitter p-p, average power, crossing percentage, rise time, fall time, one level, zero level, eye height, eye width, signal to noise (Q-factor), duty cycle distortion, bit rate, eye amplitude, opening factor, and contrast ratio.

19. The method of claim 15, wherein said generating signal analysis results based on said image processing comprises:
performing one or more mask tests based on the signal image data.

20. The method of claim 1, wherein said outputting the signal analysis results comprises outputting the signal analysis results to one or more of:
a display device;
a storage medium; and
an external system over a network.

21. A system for analyzing signals, the system comprising:
a processor;
a memory medium coupled to the processor;
an input; and
an output;
wherein the input is operable to receive signal image data corresponding to a signal;
wherein the memory medium stores program instructions which are executable by the processor to:
perform image processing on the received signal image data; and
generate signal analysis results based on said image processing; and
wherein the output is operable to output the signal analysis results.

22. A system for analyzing signals, the system comprising:
means for receiving signal image data corresponding to a signal;
means for performing image processing on the received signal image data;
means for generating signal analysis results based on said image processing; and
means for outputting the signal analysis results.

23. A carrier medium which stores program instructions for analyzing signals, wherein the program instructions are executable to perform:
receiving signal image data corresponding to a signal;
performing image processing on the received signal image data;
generating signal analysis results based on said image processing; and
outputting the signal analysis results.
